(19) United States
(12) Patent Application Publication
(10) Pub. No.: US 2003/0186726 A1
(43) Pub. Date: Oct. 2, 2003

(54) Base station and mobile station

(76) Inventor: Hidenori Akita, Tokyo (JP)

Correspondence Address: VOLENTINE FRANCOS, P.L.L.C., Suite 150, 12200 Sunrise Valley Drive, Reston, VA, 20191, US

(21) Appl. No.: 10/364,367

(22) Filed: Feb. 12, 2003

(30) Foreign Application Priority Data
Feb. 14, 2002 (JP) 036270/2002

(51) Int. Cl. H04Q 7/30

(52) U.S. Cl. 455/562.1; 455/101; 455/277.2

(57) ABSTRACT

A base station for communicating with a mobile station, wherein the base station includes a first antenna which extends vertically relative to a reference plane, a second antenna which extends horizontally relative to the reference plane, a switching circuit which is electrically connected to the first and second antennas and which selectively outputs a signal from either one of the first and second antennas according to a control signal and a control circuit which supplies the control signal to the switching circuit in response to a signal received from the mobile station via at least one of the first and second antennas.

### BACKGROUND OF THE INVENTION

1. Field of the Invention

The present invention relates, in general, to wireless communication systems and, more particularly, to an antenna switching of a base station.

This is a counterpart of and claims priority to Japanese patent application Serial Number 36270/2002, filed on Feb. 14, 2002, the subject matter of which is incorporated herein by reference.

2. Description of the Related Art

A conventional wireless communication system is disclosed in Japanese Patent Application Laid-Open No. 10-145273, Nakano et al. The conventional base station receives a signal from a mobile station using a horizontal polarized wave element and a vertical polarized wave element. The conventional base station compares a transmission power of the signal received by the horizontal polarized wave element and a transmission power of the signal received by the vertical polarized wave element. The conventional base station selects either one of the horizontal and vertical polarized wave elements which has the transmission power stronger than the other.

However, the transmission power is frequently changed by a transmission condition, for example, a reflection by buildings located between the mobile station and the base station. The frequent changing causes antennas to be switched frequently. Frequently switching antennas cause noise to be occurred in communication.

### SUMMARY OF THE INVENTION

According to one aspect of the present invention, there is provided a base station for communicating with a mobile station, wherein the base station includes a first antenna which extends vertically relative to a reference plane, a second antenna which extends horizontally relative to the reference plane, a switching circuit which is electrically connected to the first and second antennas and which selectively outputs a signal from either one of the first and second antennas according to a control signal and a control circuit which supplies the control signal to the switching circuit in response to a signal received from the mobile station via at least one of the first and second antennas.

The novel features of the invention will more fully appear from the following detailed description, appended claims and the accompanying drawings.

### BRIEF DESCRIPTION OF THE DRAWINGS

FIG. 1 is a block diagram showing a wireless communication system having a base station and a mobile station according to a first preferred embodiment of the present invention.

FIG. 2 is a block diagram showing a transmitter-receiver circuit of the base station according to the first preferred embodiment of the present invention.

FIG. 3 is a block diagram showing the mobile station according to the first preferred embodiment of the present invention.

FIG. 4 is a block diagram showing a wireless communication system having a base station and a mobile station according to a second preferred embodiment of the present invention.

FIG. 5 is a block diagram showing a wireless communication system having a base station and a mobile station according to a third preferred embodiment of the present invention.

### DETAILED DESCRIPTION OF THE PREFERRED EMBODIMENTS

The preferred embodiments of the present invention will be described. However, the invention is not limited to the specific embodiments. Moreover, not all the combinations of the characteristics of the present invention described in the embodiments are essential to the present invention.

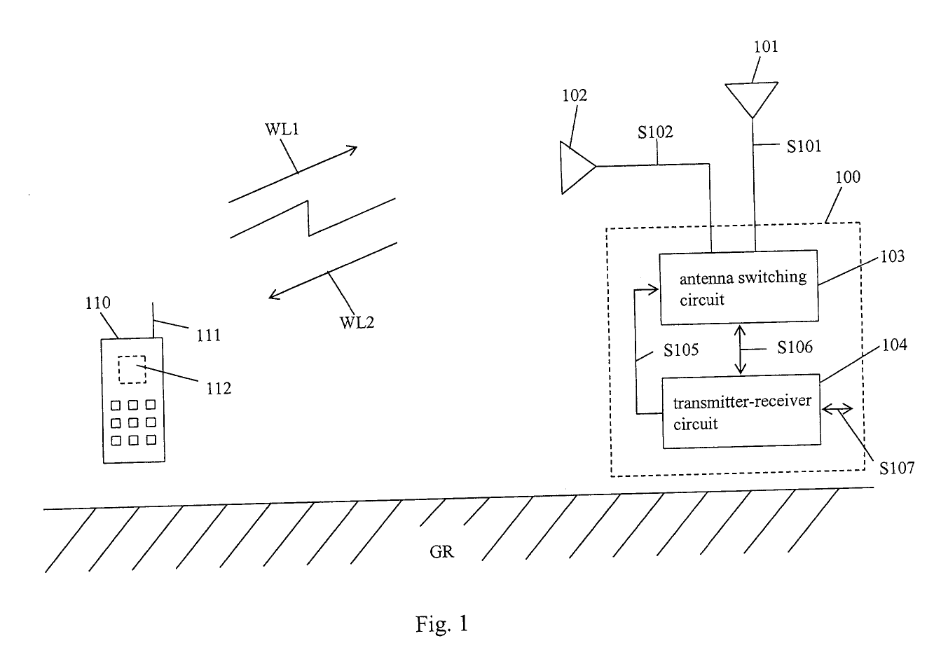

A wireless communication system according to a first preferred embodiment of the present invention will be described with reference to FIGS. 1-3. FIG. 1 is a block diagram showing the wireless communication system according to the first preferred embodiment of the present invention. The wireless communication system comprises a base station 100 and a mobile station 110.

The base station 100 comprises a first antenna 101, a second antenna 102, a switching circuit (antenna switching circuit) 103 and a control circuit (transmitter-receiver circuit) 104.

The first antenna 101 extends vertically relative to a reference plane GR, for example, the ground plane, and transmits/receives mainly a transverse-magnetic wave to/from the mobile station 110. The second antenna 102 extends horizontally relative to the reference plane GR, and transmits/receives mainly a transverse-electric wave to/from the mobile station 110. In the other words, when the received signal WL1 from the mobile station 110 is the transverse-magnetic wave, a received power of a signal S101 received by the first antenna 101 is stronger than that of a signal S102 received by the second antenna 102. When the received signal WL1 is the transverse-electric wave, the received power of the signal S102 received by second antenna 102 is stronger than that of the signal S101 received by the first antenna 101.

The switching circuit 103 is electrically connected to the first antenna 101 and the second antenna 102, and selectively outputs a signal from either one of the first and second antennas 101 and 102 as a transmission signal S106 according to a control signal (switching control signal) S105.

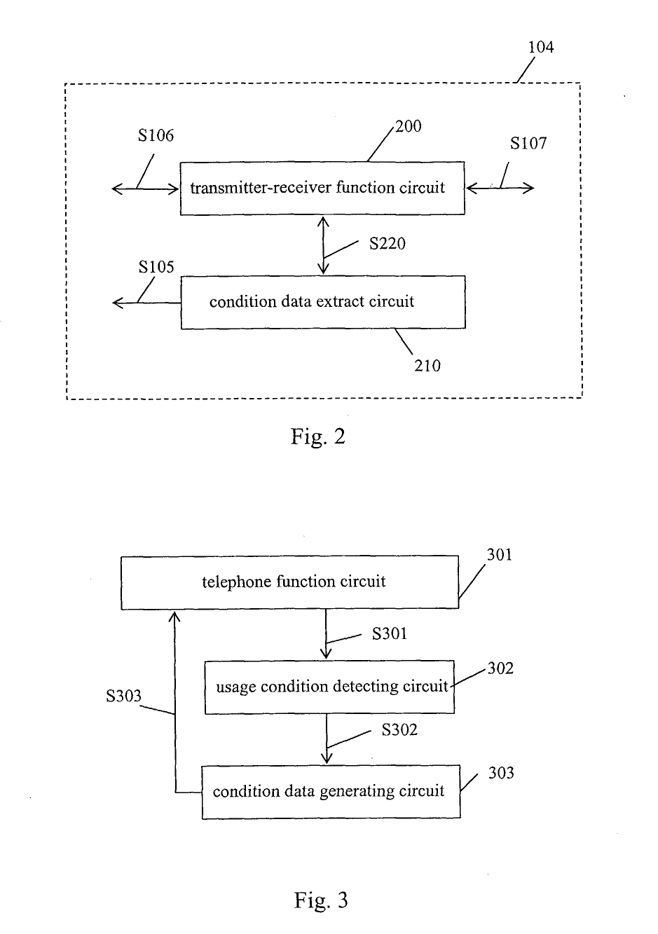

The control circuit 104 supplies the control signal S105 to the switching circuit 103 in response to a signal received from the mobile station 110 via at least one of the first and second antennas 101 and 102. FIG. 2 is a block diagram of the transmitter-receiver circuit 104 the base station of the present invention of the present invention. The transmitter-receiver circuit 104 comprises a transmitter-receiver function circuit 200 and a condition data extract circuit 210. The transmitter-receiver function circuit 200 transmits the signal S106 to an exchange device, etc. as a signal S107. The transmitter-receiver function circuit 200 transmits the signal S107 to the switching circuit 103 as the signal S106. The condition data extract circuit 210 extracts a condition data S220 from the signal S106, and provides a control signal S105 for the switching circuit 103 according to the condition data S220. For example, when the first antenna 101 is been using and when the condition data S220 shows that angle of the mobile station 110 is approximately horizontal reflect to the reference plane GR, the condition data extract circuit 210 provides the control signal S105 which indicates receiving the signal from the second antenna 102 for the switching circuit 103. For example, when the first antenna 101 is been using and when the condition data S220 shows that the kind of communication is not voice data but data communication, the condition data extract circuit 210 provides the control signal S105 which indicates receiving the signal from the second antenna 102 for the switching circuit 103.

The mobile station 110 has a whip antenna (monopole antenna) 111 which protrudes from a surface of the mobile station 110 and has a built-in antenna (inverted-F antenna) 112 which is embedded in the mobile station 110. The whip antenna 111 is used for receiving and transmitting, and the built-in antenna 112 is used for receiving. Diversity reception is realized at the mobile station 110 by antennas 111 and 112. An antenna gain of the mobile station 110 depends on a gain of the monopole antenna 111. The characteristics of a signal to be transmitted relative to a polarized wave side depend on an angle of the monopole antenna relative to the reference plane GR. The angle of the mobile station relative to the reference plane GR is equivalent to the angle of the monopole antenna relative to the reference plane GR. When the mobile station is in a pocket of a jacket, the angle of the monopole antenna is approximately vertical. When the mobile station is placed at a user's ear to hear the other person's voice, the angle of the antenna is approximately diagonal with respect to the reference plane GR. When the keypad of the mobile station is used to input data for display on a screen of the mobile station, for instance, or when the screen is being viewed such as when connected to a target internet server, the angle of the monopole antenna is approximately horizontal. FIG. 3 is a block diagram showing the mobile station 110 of the first preferred embodiment of the present invention. The mobile station 110 comprises a transmitter (telephone function circuit) 301, a usage condition detecting circuit 302 and a data generator (condition data generating circuit) 303. The transmitter 301 has a general function of the mobile station and also has a browser and a mailer according to need. The transmitter 301 generates the signal WL1 to be transmitted which has a condition data S303 and voice data or information of data communication, and transmits it to the base station 100. It is convenient for the base station 100 that a frame header for the signal WL1 has a flag bit which shows that the signal WL1 has the condition data S303. The usage condition detection circuit 302 has a function which detects the angle of the mobile station 110 relative to the reference plane GR and a kind of communication to be transferred, for example, voice data, data communication and so on. The usage condition detection circuit 302 generates a detection result which is provided to the data generator 303 as a detection result signal S302. The kind of communication can be detected by watching an internal state of the transmitter 301. Also, the angle of the mobile station 110 relative to the reference plane can be detected using some sensors. The data generator 303 generates a condition signal (condition data) S303 which is provided for the transmitter 301 based on the detection result signal S302.

The operation of the wireless communication system of the first preferred embodiment of the present invention will be described with reference to FIGS. 1-3.

The usage condition detecting circuit 302 of the mobile station 110 detects the angle of the mobile station 110 relative to the reference plane GR and/or a kind of communication to be transferred and generates the detection result signal S302 based on the detection result. The data generator 303 generates a condition signal S303 which is provided for the transmitter 301 based on the detection result signal S302. The transmitter 301 generates the signal WL1 to be transmitted which has the condition data S303 and voice data or information of data communication, and transmits it to the base station 100.

The condition data extract circuit 210 of the base station 100 extracts the condition data S220 from the signal S106 and provides the control signal S105 for the switching circuit 103 if necessary. The switching circuit 103 selects either one of the first and second antennas according to the control signal S105.

The mobile station according to the first preferred embodiment of the present invention detects its own angle relative to the reference plane GR and a kind of communication to be transferred, and provides its information for the base station. The base station according to the first preferred embodiment of the present invention selects either one of the first and second antennas according to its information. The wireless communication system according to the first preferred embodiment of the present invention does not change an antenna based on transmission condition. Therefore, the wireless communication system according to the first preferred embodiment of the present invention frequently needs not to change the antenna and reduces noise which is occurred by changing the antenna, causing reliability in communication to improve. For example, when many buildings are between the base and mobile stations, even though an angle of the mobile station relative to the reference plane is approximately horizontal, the traverse-magnetic wave may be received by the base station due to reflection of buildings. This situation easily changes due to moving the mobile station. In this case, if the base station frequently changes the antenna according to transmission condition, noise is occurred by changing the antenna, causing reliability in communication to be low. However, the wireless communication system according to the first preferred embodiment of the invention does not change an antenna based on transmission condition, causing reliability in communication to improve.

In the case of site diversity where the mobile station 110 receives a plurality of signals transmitted from a plurality of base stations, the mobile station 110 may also output the condition data S220 to the base stations which surround the base station 100. The base stations which surround the base station 100 change their respective antenna in the same manner as the base station 100. Therefore, reliability in site diversity communication is improved as well.

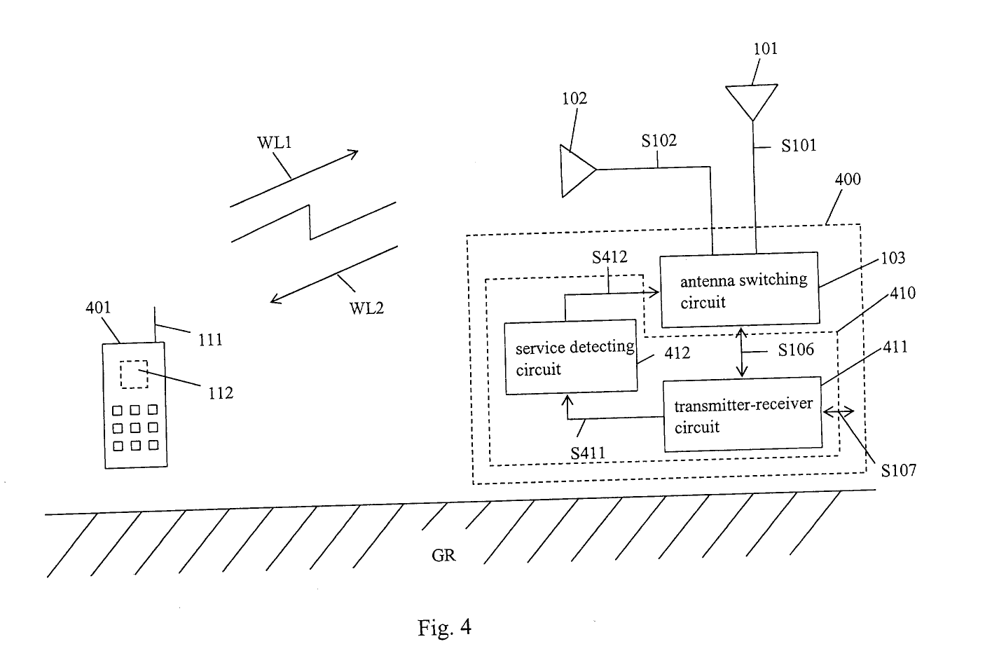

A wireless communication system according to a second preferred embodiment of the present invention will be described with reference to FIG. 4. FIG. 4 is a block diagram showing the wireless communication system according to the second preferred embodiment of the present invention. The wireless communication system comprises a base station 400 and a mobile station 401.

The base station 400 comprises a first antenna 101, a second antenna 102, a switching circuit (antenna switching circuit) 103 and a control circuit 410. The control circuit 410 comprises a transmitter-receiver circuit 411 and a service detecting circuit 412. The transmitter-receiver 411 does not have the condition data extract circuit 210 shown in FIG. 2.

The service detecting circuit 412 is electrically connected to the transmitter-receiver circuit 411 and the switching circuit 103, and detects a kind of communication according to data rate of the signal WL1 transmitted from the mobile station 401. The service detecting circuit 412 provides a control signal S412 for the switching circuit 103 according to the detecting result. Data rate for voice communication is from 1.2 kbps to 2.4 kbps. Upper limit of data rate for data communication in Personal Digital Cellar (PDC) system is 14 kbps (Upper limit that the user can use is 9.6 kbps).

The mobile station 401 does not have the usage condition detecting circuit 302 and the condition data generating circuit 303 which are shown in FIG. 3.

The base station according to the second preferred embodiment of the present invention selects either one of the first and second antennas according to data rate of the signal transmitted from the mobile station. The wireless communication system according to the second preferred embodiment of the present invention does not change an antenna based on transmission condition. Therefore, the wireless communication system according to the second preferred embodiment of the present invention frequently needs not to change the antenna and reduces noise which is occurred by changing the antenna, causing reliability in communication to improve.

In addition, the mobile station according to the second preferred embodiment of the present invention needs not to add the usage condition detecting circuit 302 and the condition data generating circuit 303. The wireless communication system according to the second preferred embodiment of the present invention uses existing mobile station.

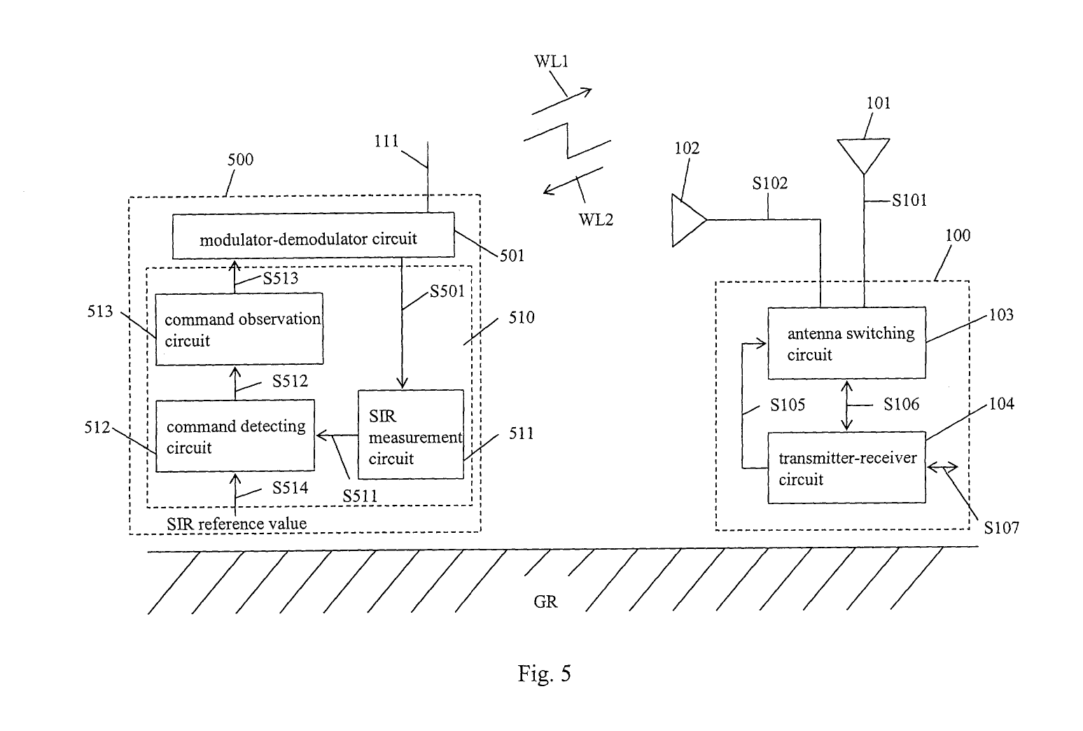

A wireless communication system according to a third preferred embodiment of the present invention will be described with reference to FIG. 5. FIG. 5 is a block diagram showing the wireless communication system according to the third preferred embodiment of the present invention. The wireless communication system comprises a base station 100 and a mobile station 500.

The mobile station 500 comprises a modulator-demodulator circuit 501 and a transmission power controller circuit 510. The modulator-demodulator circuit 501 is coupled to an antenna 111, modulates a transmitting signal WL1, demodulates a receiving signal WL2 and outputs a demodulated signal S501. The transmission power controller circuit 510 generates data which causes the base station 100 to choose a first antenna 101 or a second antenna 102 based on a transmission quality of the demodulated signal S501. The transmission power controller circuit 510 comprises a Signal to Interference Ratio (SIR) measurement circuit 511, a command detecting circuit 512 and a command observation circuit 513.

The SIR measurement circuit 511 which is coupled to the modulator-demodulator circuit 501 measures an SIR value of the demodulated signal S501 and outputs the SIR value S511. SIR is just one example of an indicator of receiving signal quality. It is possible instead to use a Signal to Noise Ratio (S/N ratio) or a Bit Error Rate (BER).

The command detecting circuit 512 is coupled to the SIR measurement circuit 511, compares the SIR value S511 and a first value (SIR reference value) S514 and generates a command signal (transmitting power control command) S512 based on the comparison result. When the SIR value S511 is less than the first value S514, that is the quality of the received signal WL2 is poor, the command detecting circuit 512 generates the command signal S512 causing the base station 100 to increase transmission power of the signal WL2. The more transmission power is increased, the larger the ratio of desired wave power to interference wave power becomes causing reliability in communication to be improved. When the SIR value S511 is much greater than the first value S514, that is the quality of the received signal WL2 is unnecessary high, the command detecting circuit 512 generates the command signal S512 causing the base station 100 to decrease transmission power of the signal WL2. To decrease transmission power resolves the near-far problem and secures transmission capacity.

The command signal S512 is supplied to the modulator-demodulator circuit 501 through the command observation circuit 513.

The command observation circuit 513 monitors the input command signal S512 to determine whether the quality of the receiving signal WL2 is either poor or unnecessary high for a given period of time, and generates the direction signal S513 when the number of the input command signal S512 exceeds a second value. It goes without saying that the command observation circuit 513 may time the input command signal S512. When the command observation circuit 513 generates a direction signal S513 which is the same as the command signal S512 unless the quality of the receiving signal WL2 is either poor or unnecessary high for a given period of time. In that case, the direction signal S513 is generated to order the base station 100 to change the antenna. In any case, the signal S513 is contained the signal WL1. It goes without saying that the command observation circuit 513 may be provided in the base station.

The wireless communication system according to the third preferred embodiment of the present invention frequently needs not to change the antenna and reduces noise which is occurred by changing the antenna causing reliability in communication to improve.

In addition, the wireless communication system according to the third preferred embodiment of the present invention changes the antenna before the transmission power in the base station is increased. The wireless communication system according to the third preferred embodiment of the present invention secures transmission capacity.

While the preferred form of the present invention has been described, it is to be understood that modifications will be apparent to those skilled in the art without departing from the spirit of the invention.

The scope of the invention, therefore, is to be determined solely by the following claims.

What is claimed:

1. A base station for communicating with a mobile station, said base station comprising;
a first antenna which extends vertically relative to a reference plane;
a second antenna which extends horizontally relative to the reference plane;
a switching circuit which is electrically connected to the first and second antennas, and which selectively, outputs a signal from either one of the first and second antennas according to a control signal; and
a control circuit which supplies the control signal to the switching circuit in response to a signal received from the mobile station via at least one of the first and second antennas.

2. The base station according to claim 1, wherein said control circuit causes the switching circuit to select the first antenna when the signal from the mobile station is a voice data, otherwise said control circuit causing the switching circuit to select the second antenna.

3. The base station according to claim 2, wherein said control circuit detects whether the voice data or not, based on a data rate of the signal received from the mobile station.

4. A mobile station communicating with a base station, said mobile station comprising;
an antenna;
a usage condition detection circuit which detects an antenna angle relative to a reference plane;
a data generator which is coupled to the using condition detection, and wherein the data generator generates a condition signal in response to the antenna angle; and
a transmitter which is coupled to the data generator, and wherein the transmitter notifies a condition of the mobile station to the base station.

5. A mobile station communicating with a base station, said mobile station comprising;
a modulator/demodulator circuit which is coupled to an antenna, wherein the modulator-demodulator circuit modulates a transmitting signal, and wherein the modulator-demodulator circuit demodulates a receiving signal; and
a transmission power controller circuit which generates a data to cause the base station to choose an antenna based on a transmission quality of the demodulated receiving signal.

6. The mobile station according to claim 5, wherein said transmission quality is a Signal to Interference Ratio (SIR).

7. The mobile station according to claim 5, wherein said transmission quality is a Signal to Noise Ratio (S/N ratio).

8. The mobile station according to claim 5, wherein said transmission quality is a Bit Error Rate (BER).

9. The mobile station according to claim 5, wherein said transmission power controller circuit comprises;
a Signal to Interference Ratio (SIR) measurement circuit which is coupled to the modulator/demodulator circuit, wherein the SIR measurement circuit measures an SIR value of the demodulated receiving signal;
a command detecting circuit which is coupled to the SIR measurement circuit, wherein the command detecting circuit compares the SIR value and a first value, and wherein the command detecting circuit generates a command signal based on the comparison result; and
a command observation circuit which is coupled to the modulator-demodulator circuit, wherein the command observation circuit generates a direction signal when the number of the input command signal is over a second value.

10. The mobile station according to claim 9, wherein said first value is a SIR reference value.
